(19) United States
(12) Patent Application Publication
(10) Pub. No.: US 2015/0039408 A1
(43) Pub. Date: Feb. 5, 2015

(54) SYSTEMS AND METHODS FOR ANONYMOUS COUPON REDEMPTION

(71) Applicant: Srinivasan Raman, San Jose, CA (US)

(72) Inventor: Srinivasan Raman, San Jose, CA (US)

(21) Appl. No.: 13/958,459

(22) Filed: Aug. 2, 2013

(51) Int. Cl. G06Q 30/02

(52) U.S. Cl. CPC G06Q 30/0213
USPC 705/14.15

(57) ABSTRACT

Systems and methods are disclosed for a service provider to facilitate the sale and purchase of discount coupons applicable to products buyers are interested in purchasing. A buyer may transmit information on a product to the service provider. The service provider may search a repository of coupons to find coupons applicable to the product. The coupons are available to purchase from account holders of the service provider. The service provider may transmit information on the coupons to the buyer. The buyer may select a coupon to purchase and may transmit the selection to the service provider. The service provider may purchase the coupon. If the coupon is used to purchase the product, the service provider may apply the coupon to the product, charge the buyer for the coupon and the product, credit the coupon seller's account for the sale of the coupon, and pay a merchant for the product.

### TECHNICAL FIELD

The present disclosure relates generally to electronic commerce. In particular, the present disclosure relates to methods and systems for facilitating the search and use of discount instruments such as coupons, gift certificates, gift cards, etc. by consumers when making online or offline purchases.

### BACKGROUND

Consumers are constantly looking for the best deals. To entice buyers, manufacturers, vendors, and merchants frequently offer price discounts in the form of coupons, gift certificates, gift cards, or other types of discount instruments that the consumers may apply to the purchase price of goods and services. Conventionally, consumers may clip coupons from newspapers, flyers, advertisements, etc., to present to cashiers at checkout counters. In electronic commerce including online purchases or mobile payments, consumers may similarly present electronic coupons to receive discounts on products and services. Holders of coupons, realizing that there is a market for coupons, have increasingly taken to the Internet to sell coupons they do not need. Consumers looking to buy a product may search online to purchase a coupon for the product. Consumers may receive purchased coupons electronically such as through e-mails and may apply the coupons to online purchases. However, problems with the use of coupons frequently arise, e.g., when a coupon is invalid, is not applicable to the specific product a consumer is interested in purchasing, has expired in time, or when the consumer changes his or her mind and wishes to purchase a different product to which the coupon does not apply. Merchants may also lose sale when problems in the use of coupons prevent the consumer from completing the purchase. Furthermore, even if the consumer is able to use the coupon, the consumer may not be using the coupon that yields the maximum benefit after accounting for the purchase price of the coupon. As such, it is desirable to have an efficient mechanism that would allow consumers to easily search, purchase, and use coupons and/or other discount instruments for maximum benefit with minimal inconvenience when conducting electronic commerce using discount instruments.

### BRIEF DESCRIPTION OF THE DRAWINGS

FIG. 1 shows a buyer purchasing a product from a merchant with the aid of a payment service provider to find a coupon for the product and to process payment transactions between the buyer, the merchant and the coupon seller according to one or more embodiments of the present disclosure;

FIG. 2 shows a flow chart of the process for the buyer to use the buyer device to interact with the merchant and the payment service provider of FIG. 1 to purchase a product using a coupon according to one or more embodiments of the present disclosure;

FIG. 3 shows a flow chart of the process for the payment service provider of FIG. 1 to search coupons for a specified product and to process payment transactions for the purchase of a selected coupon and the specified product requested by the buyer device according to one or more embodiments of the present disclosure;

FIG. 4 shows a flow chart of the process for the coupon seller of FIG. 1 to upload a coupon for sale by the payment service provider according to one or more embodiments of the present disclosure;

FIG. 5 shows displays on the buyer device of FIG. 1 displaying the results of the coupon search and the checkout confirmation page when the buyer selects a coupon for purchase according to one or more embodiments of the present disclosure; and

FIG. 6 is a block diagram of a computer system suitable for implementing one or more components discussed herein according to one embodiment of the present disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

Systems and methods are disclosed herein for a payment service provider in electronic commerce to facilitate the sale and purchase of discount instruments applicable to products buyers are interested in purchasing. A buyer or a merchant in a purchase transaction may transmit information on a product to the payment service provider when the buyer selects the payment service provider to process payments for the purchase of the product. The payment service provider may search a repository of coupons to find one or more coupons for sale that would yield the maximum benefit to the buyer after taking into account the face value of the coupons and their selling price. The coupons may be offered for sale by account holders of the payment service provider. The payment service provider may transmit a selection of coupons available for purchase to the buyer. The buyer may select one or more coupons to purchase and may transmit the selection to the payment service provider. The payment service provider may purchase the coupon, apply the face value of the coupon to the price of the product, charge the buyer for the price of the coupon and the discounted price of the product, credit the coupon seller's account for the sale of the coupon, and pay the merchant for the sale of the product. Advantageously, the buyer may enjoy the maximum price benefit from using a coupon, the coupon seller may sell a coupon to generate income, and the merchant may generate a sale. In one or more embodiments, the payment service provider may facilitate the sale and purchase of coupons even when the payment service provider is not processing payments for the purchase of products by buyers. In one or more embodiments, the coupons may be used for the purchases of services rendered by service vendors. The systems and methods of the present disclosure are described in embodiments using coupons as the discount instruments. However, the systems and methods described may be extended to the sale and purchase of other types of discount instruments such as gift cards, loyalty cards, store credits, etc.

The payment service provider may provide tools for coupon sellers to upload coupons to the payment service provider. The seller of the coupons, gift cards, gift certificates, etc. may be an account holder of the payment service provider. Coupons may be issued by manufacturers of the products, by merchants or marketplaces selling the products, or by the payment service provider. Coupon sellers may designate a coupon as for sale, may enter information specific to the coupon such as the merchants, the marketplaces, and/or the payment service providers that accept the coupon, the products or product categories to which the coupon may be applied, the face value of the coupon, its expiration date, whether the coupon is a stackable coupon (may be combined with other coupons), etc., and may specify the selling price of the coupon. When a coupon is sold, the payment service provider may credit the coupon seller's account for the selling price of the coupon. When the coupon is applied in the purchase transaction of a product, the payment service provider may transmit information on the coupon and the product to the buyer in a checkout confirmation page showing the selling price of the coupon, the face value of the coupons, the discounted price of the product when the coupon is applied, the total price of the product and the coupon, etc. In addition to coupons, other types of discount instruments such as gift cards, loyalty cards, store credits, etc., or a combination thereof may be searched and presented by the payment service provider to enable the buyer to derive the maximum saving.

In accordance with one or more embodiments of the present disclosure, an apparatus is disclosed. The apparatus includes one or more processors. The apparatus also includes a database for storing a repository of coupons. The apparatus further includes a memory that stores machine-readable instructions for execution by the processors to facilitate the sale and purchase of coupons. The apparatus receives, from a communication device, information on a product. The apparatus also searches the database to find one or more coupons that are applicable to the product. The apparatus further transmits the information on the coupons to the communication device. The apparatus further receives from the communication device a selected coupon that is chosen from the one or more coupons. The apparatus further purchases the selected coupon for a buyer who is an account holder of the service provider.

In accordance with one or more embodiments of the present disclosure, a method for running an application on a processor of a service provider to facilitate the sale and purchase of coupons is disclosed. The method includes receiving by the processor, information on a product from a device. The method also includes searching by the processor a repository of coupons to find one or more coupons that are applicable to the product. The method further includes transmitting by the processor information on the coupons to the device. The method further includes receiving by the processor a selected coupon that is chosen from the one or more coupons. The method further includes purchasing the selected coupon for a buyer who is an account holder of the service provider.

In accordance with one or more embodiments of the present disclosure, a non-transitory computer readable medium having computer readable code for execution by a processor to perform a method is disclosed. The method includes receiving by a service provider, information on a product from a device. The method also includes searching a repository of coupons to find one or more coupons that are applicable to the product. The method further includes transmitting information on the coupons to the device. The method further includes receiving a selected coupon that is chosen from the one or more coupons. The method further includes purchasing the selected coupon for a buyer who is an account holder of the service provider.

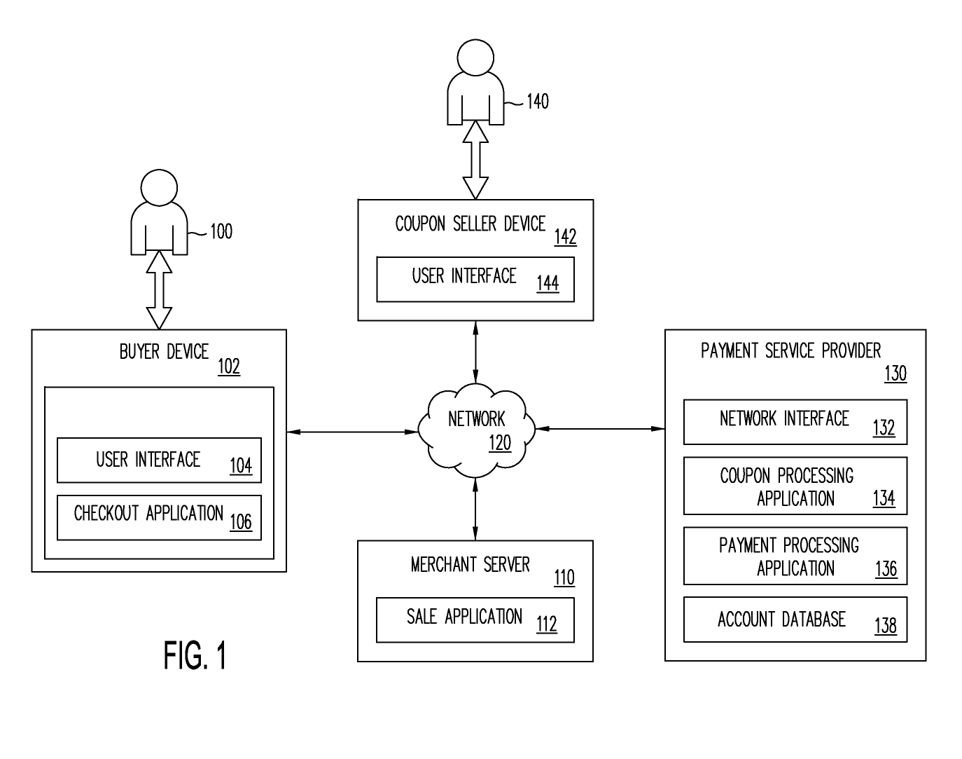

Refer now to the figures wherein the drawings are for purposes of illustrating embodiments of the present disclosure only, and not for purposes of limiting the same. FIG. 1 shows a buyer purchasing a product from a merchant with the aid of a payment service provider to find a coupon for the product and to process payment transactions between the buyer, the merchant and the coupon seller according to one or more embodiments of the present disclosure. FIG. 1 is discussed in the context of a product purchase from a merchant. However, the systems and methods discussed in FIG. 1 may be generalized to include the purchase of services from a service vendor. The systems and methods may also include the purchase of goods or services from electronic marketplaces that include a conglomeration of various merchants, service vendors, and e-commerce sites.

A buyer 100 uses a buyer device 102 to make an online purchase. Buyer 100 may use a user interface 104 on buyer device 102 to search for products over a network 120. For example, buyer 100 may open an Internet browser to search for products from various merchants over the Internet. Merchants may respond to the search inquiry by transmitting information on products that satisfy the search inquiry. For example, a merchant server 110 operated by a merchant may receive search criteria for a product search from buyer device 102 and may transmit information on products that satisfy the search criteria to buyer device 102. The information on a product may include the name of the merchant, the description of the product, and a selling price. Buyer 100 may compare products from various merchants to make a purchase decision. When buyer 100 is ready to purchase a product, buyer 100 may invoke a sale application 112 on merchant server 110 to process the purchase. Sale application 112 may allow buyer 100 to specify different payment options including using a payment service provider 130 to process the payment. When buyer 100 selects payment service provider 130, buyer device 102 may open a checkout application 106 for buyer 100 to interact with payment service provider 130.

Buyer device 102 that runs user interface 104 and checkout application 106 may be a smart phone (e.g., iPhone, Google phone, or other phones running Android, Window Mobile, or other operating systems), a tablet computer (e.g., iPad, Galaxy), personal digital assistant (PDA), a notebook computer, or various other types of wireless or wired computing devices. It should be appreciated that buyer device 102 may be referred to as a client device or a customer device without departing from the scope of the present disclosure. Buyer device 102 may communicate over a network 120 with merchant server 110 and with payment service provider 130.

Network 120 may be implemented as a single network or a combination of multiple networks. For example, in various embodiments, network 120 may include the Internet and/or one or more intranets, wireless networks (e.g., cellular, wide area network (WAN), WiFi hot spot, WiMax, personal area network (PAN), Bluetooth, etc.), landline networks and/or other appropriate types of communication networks. As such, in various embodiments, user device 102 may be associated with a particular link (e.g., a link, such as a URL (Uniform Resource Locator) to an IP (Internet Protocol) address).

Checkout application 106 interfaces with payment service provider 130 over network 120 for payment service provider 130 to assist buyer 100 in the checkout process. For example, payment service provider 130 may find coupons for products buyer 100 wishes to purchase and may process payments for the products. For payment service provider to process the payments, buyer 100 may need an account with payment service provider 130. The buyer's account may be associated with a funding source from which payments for purchases are drawn when payment service provider 130 processes the payments. When buyer 100 selects payment service provider 130 to process the payment for the product purchase, buyer 100 may be requested to login to the buyer's account through checkout application 106. If buyer 100 does not have an account, buyer 100 may be requested to establish one. Checkout application 106 may transmit information on the product to payment service provider 130. The information on the product may include the name of the merchant, the description of the product, the selling price of the product, the quantity of products to purchase, and other information received from merchant server 110 or entered by buyer 100. In one or more embodiments, the information on the product may be transmitted directly from sale application 112 of merchant server 110 to payment service provider 130. In one or more embodiments, checkout application 106 may allow buyer 100 to request payment service provider 130 to search for coupons for products offered by multiple merchants before buyer 100 commits to a product. Buyer 100 may evaluate the results of the coupon search to decide on the specific product to purchase. For example, buyer 100 may select a product when the total price of a coupon yielding the maximum benefit that is applicable to the product and the coupon-discounted price for the product is the lowest among all the products.

Payment service provider 130 searches for coupons using information for the product received from buyer device 102 or merchant server 110. Results of the coupon search are transmitted to buyer device 102 to assist buyer 100 in making the product purchase decision. When buyer 100 selects a coupon and confirms the purchase of the product, payment service provider 130 purchases the selected coupon, applies the coupon to the price of the product, and purchases the product. Payment service provider 130 may include a network interface 132, a coupon processing application 134, a payment processing application 136, and an account database 138. Network interface 132 interfaces with network 120 to exchange information with buyer device 102, merchant server 110, and with other users. For example, network interface 132 may receive information on the product user 100 is interested in purchasing from buyer device 102 or from merchant server 110, may receive information on coupons offered for sale from a coupon seller device 142, may transmit the results of the coupon search for the product to buyer device 102, may receive instructions to purchase a coupon from buyer device 102, and may transmit confirmation messages to buyer device 102, merchant server 110, and coupon seller device 142 when the product and the coupon are purchased.

Coupon processing application 134 searches for coupons applicable to a specified product. Coupon processing application 134 may search for coupons in a repository containing, among other things, coupons that are offered for sale by other account holders of payment service provider 130. The repository of coupons may be part of account database 138 so that the coupons may be linked to account holders who are seller of the coupons. When a coupon is sold, payment service provider 130 may use the link to credit the account of the seller for the proceeds of the sale. The repository may contain coupon information such as the merchants, the marketplaces, and/or the payment service providers that accept the coupon, the product or product categories for which a coupon may be used, the face value of the coupon, its price, the coupon code, any expiration date, whether the coupon is a stackable coupon, etc. Coupon processing application 134 searches the coupon information to find one or more valid coupons that are applicable to the specified product and are accepted by the merchant or the marketplace selling the product. For example, coupon processing application 134 may search for coupons, gift cards, gift certificates, etc. issued by the merchant or marketplace from whom the product is purchased, coupons issued by payment service provider 130, and/or may search for manufacturer issued coupons that are accepted by the merchant or the marketplace. In one or more embodiments, coupon processing application 134 may sort the coupons found by the level of benefits conferred by the coupons. For example, coupon processing application 134 may offset the face value of coupons by their sale price and may present to buyer device 102 a listing of coupons arranged in order of decreasing savings. In one or more embodiments, coupon processing application 134 may present a coupon that offers the maximum saving to buyer device 102. In one or more embodiments, coupon processing application 134 may determine whether coupons may be combined and may present to buyer device 102 the combination that offers the maximum saving.

A coupon seller 140 may list coupons for sale in the repository of coupons using coupon seller device 142. Coupon seller device 142 may be a smart phone (e.g., iPhone, Google phone, or other phones running Android, Window Mobile, or other operating systems), a tablet computer (e.g., iPad, Galaxy), personal digital assistant (PDA), a notebook computer, or various other types of wireless or wired computing devices. Coupon seller device 142 communicates over a network 120 with payment service provider 130. Coupon seller 140 may use a user interface 144 of coupon seller device 142 to login to his/her account with payment service provider 130. If coupon seller 140 does not have an account, coupon seller 140 may be asked to establish one. Coupons offered for sale by coupon seller 140 are linked to the account of coupon seller 140 so that when the coupons are sold, proceeds from the sale may be deposited into the seller's account. Coupon seller 140 may upload a coupon to payment service provider 130 and may enter information on the coupon such as the merchants, the marketplaces, and/or the payment service providers that accept the coupon, the product, a set of products, or a product category to which the coupon is applicable, the face value of the coupon, the coupon code, any expiration date, whether the coupon is a stackable coupon, etc. In one or more embodiments, coupon seller 140 may upload an image of the coupon. In one or more embodiments, coupon seller 140 may upload a coupon to a coupon marketplace operated by the payment service provider, or operated independently of the payment service provider. In one or more embodiments, the coupon may be applicable to shipping charges, processing fees, or other charges levied by a merchant or a marketplace for a purchase transaction. Coupon processing application 134 may use optical character recognition and/or other image recognition software to process the image of the coupon to derive pertinent information on the coupon. After uploading the coupon, coupon seller 140 may designate the coupon for sale and may enter a selling price for the coupon. In one or more embodiments, coupon seller 140 may not designate the coupon for sale or may do so at a later time if coupon seller 140 is interested in possibly using the coupon for himself/herself.

Buyer device 102 receives results of the coupon search from payment service provider 130 for viewing by buyer 100. For example, buyer device 102 may display a listing of coupons arranged in order of decreasing savings for a product. The listing may include for each coupon the face value of the coupon, the offer price of the coupon, and the saving conferred. The saving for a coupon may be derived by subtracting the face value of the coupon by the offer price of the coupon to represent the saving when buyer 100 purchases the coupon and applies the coupon to the purchase of the product. In one or more embodiments, buyer device 102 may display the coupon or the combination of coupons that provides the maximum saving for the product. In one or more embodiments, buyer device 102 may display results of the coupon search for products from multiple merchants to assist buyer 100 in making a purchase decision.

When buyer 100 is ready to purchase a coupon and the product for which the coupon is applicable, buyer 100 may select a coupon on buyer device 102. Checkout application 106 of buyer device 102 transmits the selection to payment service provider 130. Coupon processing application 134 receives the selection and generates a checkout confirmation page for the purchase of the selected coupon and the product. Payment service provider 130 transmits the checkout confirmation page to buyer device 102 for buyer 100 to confirm the purchase. The checkout confirmation page may display the description of the product, the original price of the product, the coupon selected by buyer 100, the face value of the coupon, the price of the coupon, the saving conferred by purchasing and applying the coupon, the final discounted price of the product, and the total price for the coupon and the product. Buyer device 102 displays the checkout confirmation page for buyer 100 to confirm or decline the purchase. In one or more embodiments, buyer 100 may purchase a combination of coupons if the coupons are stackable.

When buyer 100 confirms the purchase, buyer device 102 transmits to payment service provider 130 instructions to process the payment transactions. Payment processing application 136 charges the buyer's account for the price of the coupon, applies the face value of the coupon as a discount to the original price of the product, and charges the buyer's account for the discounted price of the product. Coupon processing application 134 identifies the account of the seller of the coupon through the link between the account and the coupon. To issue a payment to the seller of the coupon, payment processing application 136 credits the account of the seller of the coupon for the selling price of the coupon. If the merchant has an account with payment service provider 130, payment processing application 136 may similarly credit the account of the merchant for the discounted price of the product. If the merchant does not have an account with payment service provider 130, payment processing application 136 may transmit a message to the merchant informing the merchant to claim the payment. Payment processing application 136 may issue a confirmation message to buyer device 102 to confirm the execution of the payment transaction. The confirmation message may inform buyer 100 that buyer's account has been charged for the total of the price of the coupon and the discounted price of the product. Payment processing application 136 may transmit a confirmation message to the seller of the coupon to inform the seller that the coupon has been sold. The confirmation message may inform the seller of the coupon that the seller's account has received a credit for the price of the coupon. Payment processing application 136 may transmit a payment confirmation message to merchant server 110 to inform the merchant that the payment processing for the purchase transaction has been completed. Merchant server 110 may complete the purchase transaction such as by shipping the product to buyer 100.

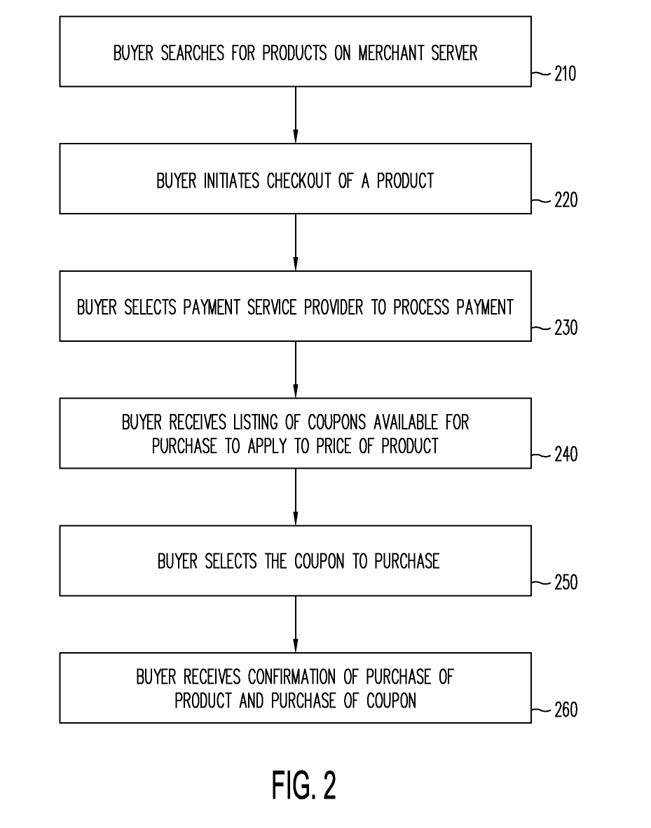

FIG. 2 shows a flow chart of the process for the buyer to use the buyer device to interact with the merchant and the payment service provider of FIG. 1 to purchase a product using a coupon according to one or more embodiments of the present disclosure.

In 210, buyer 100 uses buyer device 102 to search for products from one or more merchants. For example, buyer 100 may access a website hosted on merchant server 110 of a merchant to obtain information on products. Alternatively, buyer 100 may access a product comparison website to review information on products from multiple merchants. The information on the products may include the description and the selling price of the products. Buyer 100 may evaluate the information from the merchants to make a purchase decision.

In 220, when buyer 100 is interested to purchase a product, buyer 100 initiates a checkout of the product from buyer device 102. For example, if buyer 100 is on the website hosted by merchant server 110, buyer 100 may invoke sale application 112 of merchant server 110 to initiate the checkout. Merchant server 110 may transmit a checkout page to buyer device 102 listing the product, the price, taxes, shipping charges, etc. Buyer 100 may enter information into the checkout page to enable the merchant to execute the purchase transaction, such as the name and the shipping address of buyer 100, etc. The checkout page may present payment options for buyer 100. One of the payment options may be for buyer 100 to use payment service provider 130 to process the payment if the merchant has an account with payment service provider 130.

In 230, if buyer 100 has an account with payment service provider, buyer 100 elects payment service provider 130 to process the payment. Buyer device 102 may start checkout application 106 to request buyer 100 to login to buyer's account. When buyer 100 enters login credentials, checkout application 106 may transmit the login credentials to payment service provider 130 for payment service provider 130 to authenticate buyer 100. After buyer 100 is authenticated, buyer 100 may use a balance in the account or a funding source such as a bank account that is linked to the account to pay for the purchase. If buyer 100 does not have an account with payment service provider 130, checkout application 106 may request buyer 100 to establish an account and to link the new account to a funding source before payment service provider 1.30 may process the payment. Checkout application 106 may transmit information on the checkout page to payment service provider 130 to enable payment service provider 130 to search for coupons applicable to the product. The information may include the name of the merchant, the account number of the merchant, the product to be purchased, a product code, the price of the product, the quantity to be purchased, etc. In one or more embodiments, merchant server 110 may transmit the information directly from merchant server 110 to payment service provider 130. Payment service provider 130 may use the information to search for coupons that are applicable to the product. The coupons may be offered for sale by other account holders or may be reserved for use by buyer 100 from previous purchases or previous uploads by buyer 100. In one or more embodiments, buyer 100 may request payment service provider 130 to search for coupons for one or more specified products when buyer 100 has not decided on which product to purchase. Buyer 100 may enter information on the products such as the description of the products, the product code, any preferred merchants, etc., into checkout application 106 without going through the checkout page of merchant server 110. Buyer 100 may evaluate the results of the coupon search from payment service provider 130 to determine which product to purchase.

In 240, buyer device 102 receives the results of the coupon search from payment service provider 130. The results may include a listing of the coupons that are applicable to the product arranged in order of decreasing savings. Each coupon in the listing may include the face value of the coupon, the price for the coupon, the saving calculated as the face value of the coupon subtracted by the price for the coupon, the coupon code, the expiration date, etc. In one or more embodiments, the results may include just the coupon that provides the maximum saving. In one or more embodiments, when buyer 100 is comparison shopping between multiple products, the results may include the listing of coupons or the coupon that provides the maximum saving for each product. In this scenario, buyer 100 may evaluate the coupons to determine which product to purchase and may search for the product from merchants as in 210.

In 250, buyer 100 selects the coupon applicable to the product for purchasing on buyer device 102. For example, buyer 100 may select the coupon that provides the maximum saving. Checkout application 106 may transmit the coupon selection to payment service provider 130 and may receive a checkout confirmation page back from payment service provider 130. The checkout confirmation page may display information on the product such as the description of the product, its original price, the discounted price after applying the coupon, the name of the merchant, etc. The checkout confirmation page may also display information on the selected coupon such as the face value of the coupon, the price for the coupon, the saving conferred by the coupon, etc. The checkout confirmation page may display the total purchase price as the sum of the discounted price of the product and the price for the coupon. Buyer 100 may be asked to confirm or to decline the purchase. When buyer 100 confirms the purchase, checkout application 106 may instruct payment service provider 130 to purchase the coupon, apply the face value of the coupon to the original price of the product, purchase the product, and charge the account of buyer 100 for the total purchase price of the coupon and the product. In 260, buyer device 102 receives a payment confirmation page from payment service provider 130 confirming the successful execution of the payment transactions.

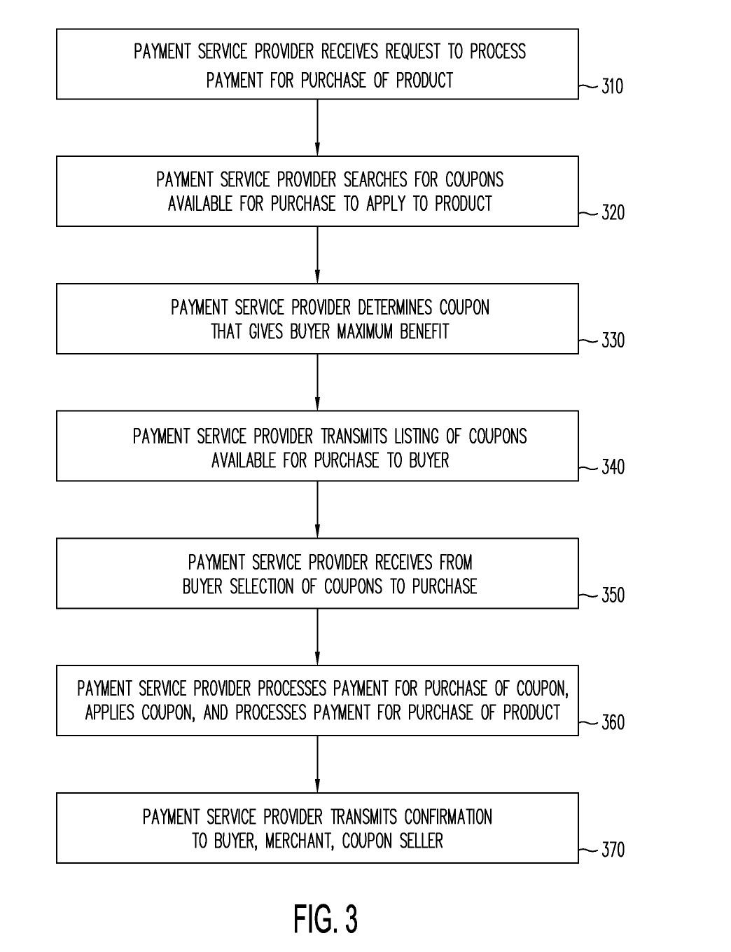

FIG. 3 shows a flow chart of the process for the payment service provider of FIG. 1 to search coupons for a specified product and to process payment transactions for the purchase of a selected coupon and the specified product requested by the buyer device according to one or more embodiments of the present disclosure.

In 310, payment service provider 130 receives a request to process payment for a product purchase from buyer device 102. The product may be purchased from a merchant who has an account with payment service provider 130. Similarly, buyer 100 may need to have an account with payment service provider 130 for payment service provider 130 to process the payment. Payment service provider 130 may request buyer 100 to provide login credentials. If buyer 100 does not have an account, payment service provider 130 may ask buyer 100 to establish an account and to link the account with a funding source. After payment service provider 130 receives login credentials of buyer 100 and buyer 100 is authenticated, payment service provider 130 may receive information on the product from buyer device 102. The information may include the name of the merchant, the account number of the merchant, the product to be purchased, the product code, the price of the product, the quantity to be purchased, etc. In one or more embodiments, payment service provider 130 may receive the information from the merchant. Payment service provider 130 may use the information to search for coupons applicable to the purchase of the product. In one or more embodiments, payment service provider 130 may receive from buyer device 102 a standalone request that is not part of payment processing for a product purchase to search for coupons for one or more products. Payment service provider 130 may receive information such as the description of the products, the product codes, and any preferred merchants for buyer 100, etc. In this scenario, payment service provider 130 may not require buyer 100 to provide login credentials.

In 320, payment service provider 130 searches for coupons using the product information received from buyer device 102 or from the merchant. Payment service provider 130 may search for the coupons in a repository containing, among other things, coupons that are offered for sale by all account holders. The repository may also contain coupons that are reserved for use by buyer 100 from previous uploads or from previous purchases. The coupons in the repository may be linked with account holders who are sellers or owners of the coupons. The repository may contain information on the coupons such as the merchants, the marketplaces, and/or the payment service providers that accept a coupon, the product, a set of products, or a product category for which the coupon may be used, the face value of the coupon, the selling price of the coupon, the coupon code, any expiration date, whether the coupon is a stackable coupon, etc. Payment service provider 130 may search the repository to find valid coupons, if any, which are applicable to the product and are accepted by the merchant or the marketplace selling the product. For example, payment service provider 130 may search for coupons issued by the merchant or marketplace from whom the product is purchased, coupons issued by payment service provider 130, and/or manufacturer issued coupons that are accepted by the merchant or the marketplace. The coupons found may be coupons offered for sale by other account holders or may be coupons owned by buyer 100.

In 330, payment service provider 130 determines the coupon that gives buyer 100 the maximum benefit from among the coupons found. For example, the coupon that provides the maximum benefit may be the one that gives the maximum saving calculated by subtracting the face value of the coupon by the selling price of the coupon. If buyer 100 already owns a coupon, the saving may simply be the face value of the coupon since buyer 100 does not need to purchase the coupon. In one or more embodiments, even if a coupon owned by buyer 100 provides less saving than that from purchasing a coupon, payment service provider 130 may designate the owner's coupon as providing the maximum saving if it is about to expire. In one or more embodiments, payment service provider 130 may determine if a combination of coupons may give the maximum saving. In one or more embodiments, payment service provider 130 may generate a listing of coupons arranged in order of decreasing savings.

In 340, payment service provider 130 transmits the listing of coupons arranged in order of decreasing saving to buyer device 102. In one or more embodiments, payment service provider 130 may transmit an unsorted list of coupons and buyer device 102 may sort the coupons using criteria selected by buyer 100. In one or more embodiments, payment service provider 130 may transmit the coupon that gives the maximum benefit to buyer device 102. If there is more than one product in a payment transaction or if buyer 100 has requested a coupon search for multiple products to help in making a purchase decision, payment service provider 130 may transmit one or more coupons for each product. Each coupon transmitted may include information on the face value of the coupon, the price for the coupon, the saving calculated as the face value of the coupon subtracted by the price for the coupon, the coupon code, the expiration date, whether buyer 100 owns the coupon, etc. Buyer 100 may review the coupon information and may select a coupon to purchase or may use a coupon that buyer 100 already owns for the product.

In 350, payment service provider 130 receives from buyer device 102 the coupon selected for the product purchase. If the coupon is owned by another account holder, payment service provider 130 may purchase the coupon from the account holder to apply the face value of the coupon to the price of the product. If the coupon is owned by buyer 100, payment service provider 130 may apply the coupon to the product purchase. Payment service provider 130 may remove the coupon from the repository after it's purchased and used. In one or more embodiments, buyer 100 may desire to acquire a coupon for use at a later time. Payment service provider 130 may purchase the coupon from the seller but may leave the coupon in the repository. The ownership of the coupon may be transferred from the seller to buyer 100 by moving the link to the coupon from the account of the seller to the account of buyer 100. Payment service provider 130 may transmit a checkout confirmation page to buyer device 102. The checkout confirmation page may display the face value of the coupon, the price for the coupon if it is to be purchased, the saving provided by the coupon, the description of the product, its original price, the discounted price after applying the coupon, the total price of the product and the coupon, etc. The checkout confirmation page may request buyer 100 to confirm the purchase of the product and the coupon, the purchase of the coupon only, or to decline all purchases.

In 360, payment service provider 130 receives a confirmation from buyer device 102 of the purchase. If the purchase is for the product and the coupon, payment service provider 130 purchases the coupon from the seller, applies the face value of the coupon as a discount to the price of the product such as by applying the coupon code to the purchase, and charges the account of buyer 100 for the price of the coupon and the discounted price of the product. Payment service provider 130 credits the account of the seller of the coupon for the selling price of the coupon and credits the account of the merchant for the discounted price of the product. If the merchant does not have an account with payment service provider 130, payment service provider 130 may hold the funds due the merchant in reserve until the merchant claims the funds. In one or more embodiments, if the coupon is already owned by buyer 100, payment service provider 130 may apply the face value of the coupon as a discount to the price of the product, and may charge the account of buyer 100 for the discounted price of the product only. In one or more embodiments, if buyer 100 wishes to purchase the coupon for later use, payment service provider 130 may purchase the coupon from the seller and may transfer an amount equal to the price of the coupon from the account of buyer 100 to the account of the seller. Payment service provider 130 may transfer the ownership of the coupon from the seller to buyer 100 and may hold the coupon in the repository for later use by buyer 100.

In 370, payment service provider 130 transmits a confirmation message to buyer device 102 to confirm the purchase of the product and the coupon, the product only, or the coupon only. The confirmation message may inform buyer 100 that buyer's account has been charged for the amount of the purchase. Payment service provider 130 may transmit a message to the merchant such as merchant server 110 to confirm the completion of the payment transaction for the product purchase. The confirmation message may inform the merchant that buyer 100 has used a coupon for the product purchase and that the merchant's account has received a credit for the discounted price of the product. If the merchant does not have an account with payment service provider 130, the confirmation message may include instructions for the merchant to claim the proceeds of the sale. Payment service provider 130 may transmit a message to the seller of the coupon to confirm the sale of the coupon. The confirmation message may inform the seller that the seller's account has received a credit for the price of the coupon.

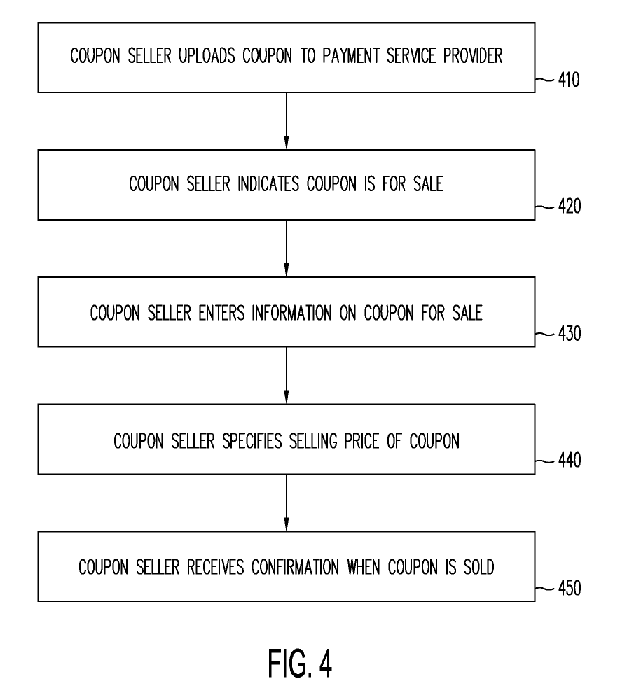

FIG. 4 shows a flow chart of the process for the coupon seller of FIG. 1 to upload a coupon for sale by the payment service provider according to one or more embodiments of the present disclosure. Coupon seller 140 may use coupon seller device 142 to communicate with payment service provider 130.

In 410, coupon seller 140 uploads a coupon to payment service provider 130 from coupon seller device 142. Coupon seller 140 may provide login credentials for payment service provider 130 to authenticate coupon seller 140. When coupon seller 140 is authenticated, coupon seller 140 may transmit an image of the coupon from coupon seller device 142. Payment service provider 130 may link the coupon to the account of coupon seller 140 as the owner of the coupon and may place the coupon in the repository of coupons. In one or more embodiments, coupon seller 140 may transmit information on the coupon to payment service provider 130 instead of uploading an image of the coupon. In one or more embodiments, coupon seller 140 may upload a coupon to a coupon marketplace operated independently of payment service provider 130.

In 420, coupon seller 140 indicates to payment service provider 130 that the coupon is for sale on coupon seller device 142. Once the coupon is designated for sale, payment service provider 130 may search the coupon to determine if the coupon is applicable to specified products and/or merchants, marketplaces in search requests from any account holders. A coupon that is not for sale is held for use only by its owner. As such, payment service provider 130 may search the coupon that is not for sale only in search requests initiated by the owner of the coupon.

In 430, coupon seller 140 enters information on the coupon into coupon seller device 142 for transmission of the information to payment service provider 130. The information may include the merchants, the marketplaces, and/or the payment service providers that accept the coupon, the product or products for which the coupon may be used, the face value of the coupon, the coupon code, any expiration date, whether the coupon is a stackable coupon, etc. In one or more embodiments, payment service provider 130 may use optical character recognition software or other image processing software to derive the information from the uploaded image of the coupon. Payment service provider 130 may associate the information with the coupon in the repository of coupons. In one or more embodiments, the coupon may be applicable to shipping charges, processing fees, or other charges levied by a merchant or a marketplace in a purchase transaction.

In 440, if the coupon is designated for sale, coupon seller 140 specifies the selling price of the coupon into coupon seller device 142 for transmission of the information to payment service provider 130. After coupon seller 142 completes uploading information on the coupon to payment service provider 130, coupon seller 142 may log out. The coupon in the repository is linked to the account of coupon seller 140 and the information associated with the coupon may be searched by payment service provider 130 to determine if the coupon may be validly used for a product.

In 450, if a buyer purchases the coupon, payment service provider deposits an amount equal to the selling price of the coupon into the account of coupon seller 140. If the coupon is used to purchase a product, the coupon is released from the repository of coupons. If the coupon is acquired by the buyer for later use, the coupon may remain in the repository of coupons. However, the ownership of the coupon is transferred from coupon seller 140 to the buyer by establishing a link from the coupon to the account of the buyer. Coupon seller 140 may receive a confirmation message from payment service provider 130 confirming the sale of the coupon. The confirmation message may inform coupon seller 140 that the seller's account has received a credit for the price of the coupon.

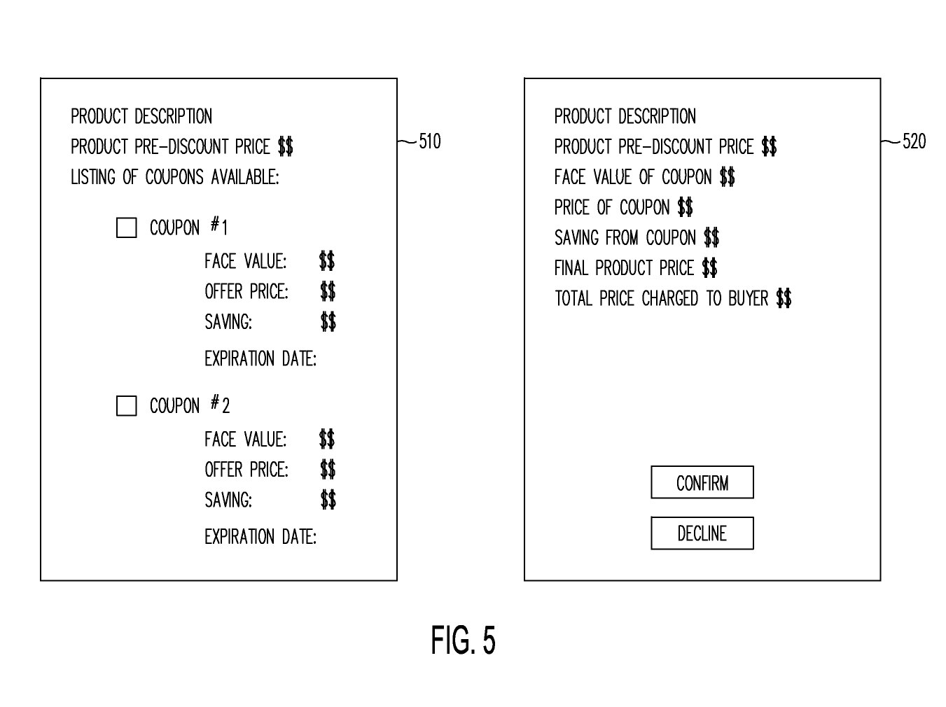

FIG. 5 shows displays on the buyer device of FIG. 1 displaying the results of the coupon search and the checkout confirmation page when the buyer selects a coupon for purchase according to one or more embodiments of the present disclosure. Buyer device 102 may receive the results of the coupon search and the checkout confirmation page from payment service provider 130 when buyer 100 interacts with payment service provider 130 to search and to purchase a coupon during the checkout of a product purchase.

In 510, buyer device 102 displays the results of the coupon search for a product received from payment service provider 130. The results may be displayed to buyer 100 during step 240 of FIG. 2. The display includes a product description, a product pre-discount price showing the original price of the product before any coupon is applied, and a listing of coupons that are applicable to the product. Each coupon in the listing may include the face value of the coupon, the price for the coupon, the saving calculated as the face value of the coupon subtracted by the price for the coupon, the expiration date, etc. In one or more embodiments, the coupons in the listing may be arranged in order of decreasing savings. Buyer 100 may evaluate the listing of coupons to determine which coupon, if any, to purchase. In one or more embodiments, the listing of coupons may display only the coupon that provides the maximum saving. Buyer 100 may select the coupon to purchase by clicking a box next to a coupon. In one or more embodiments, coupons may be stackable or may be combined with gift certificates, gift cards, etc. The listing of coupons may show a combination of coupons and/or coupons combined with gift certificates, gift cards.

In 520, buyer device 102 displays the checkout confirmation page received from payment service provider 130 after buyer 100 selects a coupon to purchase for a product. The checkout confirmation page may be displayed to buyer 100 during step 250 of FIG. 2. The display includes the product description, the pre-discount price for the product, the face value of the selected coupon, the price for the selected coupon, the saving calculated as the face value of the selected coupon subtracted by the price for the selected coupon, the final product price after applying the face value of the selected coupon to the product pre-discount price, and the total price of the product and the coupon. In one or more embodiments, the checkout confirmation page may display multiple coupons if buyer 100 selects a combination of coupons to purchase for a product. The display includes buttons for buyer 100 to confirm or to decline the purchase. When buyer 100 clicks on the confirmation button, payment service provider 130 processes the purchases of the selected coupon and the product.

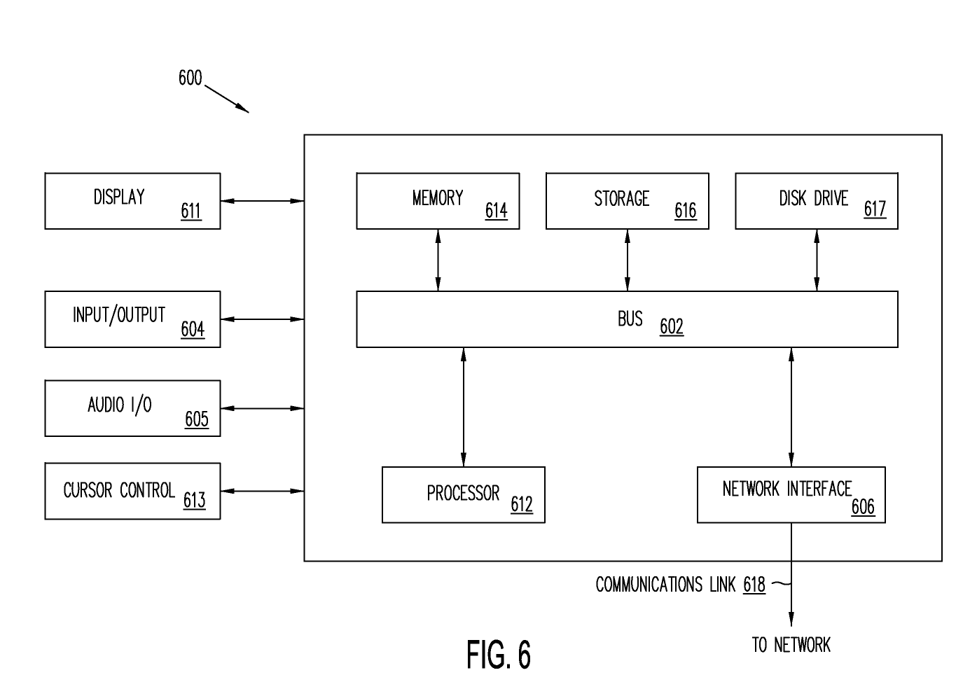

FIG. 6 is a block diagram of a computer system 600 suitable for implementing one or more embodiments of the present disclosure. In various implementations, the mobile device of the user may comprise a personal computing device (e.g., smart phone, a computing tablet, a personal computer, laptop, FDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 600 in a manner as follows. It should also be appreciated that the applications to checkout purchases, search coupons, or process payments may be implemented as applications running on computer system 600.

Computer system 600 includes a bus 602 or other communication mechanism for communicating information data, signals, and information between various components of computer system 600. Components include an input/output (I/O) component 604 that processes a user action, such as selecting keys from a keypad/keyboard, selecting one or more buttons or links, etc., and sends a corresponding signal to bus 602. I/O component 604 may also include an output component such as a display 611, and an input control such as a cursor control 613 (such as a keyboard, keypad, mouse, etc.). An optional audio input/output component 605 may also be included to allow a user to use voice for inputting information by converting audio signals into information signals. Audio I/O component 605 may allow the user to hear audio. A transceiver or network interface 606 transmits and receives signals between computer system 600 and other devices, such as another user device, a merchant server, or a payment provider server via a communication link 618 to a network. In one embodiment, the transmission is wireless, although other transmission mediums and methods may also be suitable. A processor 612, which can be a micro-controller, digital signal processor (DSP), or other processing component, processes these various signals, such as for display on computer system 600 or transmission to other devices via communication link 618. Processor 612 may also control transmission of information, such as cookies or IP addresses, to other devices.

Components of computer system 600 also include a system memory component 614 (e.g., RAM), a static storage component 616 (e.g., ROM), and/or a disk drive 617. Computer system 600 performs specific operations by processor 612 and other components by executing one or more sequences of instructions contained in system memory component 614. Logic may be encoded in a computer readable medium, which may refer to any medium that participates in providing instructions to processor 612 for execution. Such a medium may take many forms, including but not limited to, non-volatile media, volatile media, and transmission media. In various implementations, non-volatile media includes optical, or magnetic disks, or solid-state drives, volatile media includes dynamic memory, such as system memory component 614, and transmission media includes coaxial cables, copper wire, and fiber optics, including wires that comprise bus 602. In one embodiment, the logic is encoded in non-transitory computer readable medium. In one example, transmission media may take the form of acoustic or light waves, such as those generated during radio wave, optical, and infrared data communications.

Some common fauns of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Application software in accordance with the present disclosure, such as computer programs executed by a processor of the payment service provider to search for coupons applicable to products, purchase selected coupons, receive uploaded coupons, and process payments for product and coupon purchases, may be stored on one or more computer readable mediums. It is also contemplated that the application software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although embodiments of the present disclosure have been described, these embodiments illustrate but do not limit the disclosure. For example, even though a system and method is described for a payment service provider to facilitate the sale and purchase of coupons online, the system and method may be extended to the sale and purchase of coupons or other types of discount instruments offline such as at a retail store. Similarly, even though the coupons searched in the repository are owned by account holders of the payment service provider, coupons owned by non-account holders may similarly be searched. It should also be understood that embodiments of the present disclosure should not be limited to these embodiments but that numerous modifications and variations may be made by one of ordinary skill in the art in accordance with the principles of the present disclosure and be included within the spirit and scope of the present disclosure as hereinafter claimed.

We claim:

1. An apparatus of a service provider comprising:
one or more processors;
a database adapted to store a repository of discount instruments;
a memory adapted to store a plurality of machine-readable instructions wherein the memory is executed by the one or more processors to:
receive from a communication device information on a product;
search the database to find one or more discount instruments applicable to the product;
transmit information on the one or more discount instruments to the communication device;
receive from the communication device a selected discount instrument chosen from the one or more discount instruments; and
purchase the selected discount instrument for a buyer, wherein the buyer is an account holder of the service provider.

2. The apparatus of claim 1, wherein the information on the one or more discount instruments comprises a face value and a price of each of the discount instruments.

3. The apparatus of claim 2, wherein the information on the one or more discount instruments comprises the one or more discount instruments arranged in a decreasing order of savings, wherein the saving for each discount instrument is the face value of the discount instrument subtracted by the price of the discount instrument.

4. The apparatus of claim 2, wherein the information on the one or more discount instruments comprises a discount instrument determined to provide a maximum saving, wherein the saving is the face value of the discount instrument subtracted by the price of the discount instrument.

5. The apparatus of claim 2, wherein the selected discount instrument is owned by a seller who is an account holder of the service provider, and wherein the memory is further executed by the one or more processors to credit the account of the seller the price of the selected discount instrument.

6. The apparatus of claim 5, wherein the memory is further executed by the one or more processors to:
receive the information on the selected discount instrument from the seller;
store the information on the selected discount instrument in the repository of discount instruments; and
link the selected discount instrument to the seller.

7. The apparatus of claim 1, wherein the repository of discount instruments contains information on discount instruments owned by account holders of the service provider.

8. The apparatus of claim 1, wherein the information on the product comprises a price for the product.

9. The apparatus of claim 8, wherein the information on the one or more discount instruments comprises a face value of the selected discount instrument and the memory is further executed by the one or more processors to:
discount the price for the product by the face value of the selected discount instrument to generate a discounted price for the product; and
purchase the product for the buyer using the discounted price.

10. The apparatus of claim 1, wherein the account of the buyer is charged for the purchase of the selected discount instrument.

11. A method comprising:
receiving by a processor of a service provider information on a product from a device;
searching by the processor a repository of discount instruments to find one or more discount instruments applicable to the product;
transmitting by the processor information on the one or more discount instruments to the device;
receiving from the device a selected discount instrument chosen from the one or more discount instruments; and
purchasing the selected discount instrument for a buyer, wherein the buyer is an account holder of the service provider.

12. The method of claim 11, wherein the information on the one or more discount instruments comprises a face value and a price of each of the discount instruments.

13. The method of claim 12, wherein the information on the one or more discount instruments comprises the one or more discount instruments arranged in a decreasing order of savings, wherein the saving for each discount instrument is the face value of the discount instrument subtracted by the price of the discount instrument.

14. The method of claim 12, wherein the information on the one or more discount instruments comprises a discount instrument determined to provide a maximum saving, wherein the saving is the face value of the discount instrument subtracted by the price of the discount instrument.

15. The method of claim 12, wherein the selected discount instrument is owned by a seller who is an account holder of the service provider, and wherein the method further comprises crediting by the processor the account of the seller the price of the selected discount instrument.

16. The method of claim 15, wherein the method further comprises:
receiving by the processor the information on the selected discount instrument from the seller;
storing the information on the selected discount instrument in the repository of discount instruments; and
linking the selected discount instrument to the seller.

17. The method of claim 11, wherein the repository of discount instruments contains information on discount instruments owned by account holders of the service provider.

18. The method of claim 11, wherein the information on the product comprises a price for the product.

19. The method of claim 18, wherein the information on the one or more discount instruments comprises a face value of the selected discount instrument, and wherein the method further comprises:
discounting by the processor the price for the product by the face value of the selected discount instrument to obtain a discounted price for the product; and
purchasing the product for the buyer using the discounted price.

20. A non-transitory computer readable medium having computer readable code for instructing a processor to perform a method, the method comprising:
receiving by a service provider information on a product from a device;
searching a repository of discount instruments to find one or more discount instruments applicable to the product;
transmitting information on the one or more discount instruments to the device;
receiving from the device a selected discount instrument chosen from the one or more discount instruments; and
purchasing the selected discount instrument for a buyer, wherein the buyer is an account holder of the service provider.
